(19) United States
(12) Patent Application Publication
(10) Pub. No.: US 2016/0202924 A1
(43) Pub. Date: Jul. 14, 2016

(54) DIAGONAL ORGANIZATION OF MEMORY BLOCKS IN A CIRCULAR ORGANIZATION OF MEMORIES

(71) Applicant: Telefonaktiebolaget L M Ericsson (publ), Stockholm (SE)

(72) Inventors: George Madathilparambil George, Bangalore (IN); Nithin Kumar, Bangalore (IN); Nobin Mathew, Bangalore (IN)

(21) Appl. No.: 14/596,043

(22) Filed: Jan. 13, 2015

(51) Int. Cl. G06F 3/06

(52) U.S. Cl. CPC G06F 3/0619; G06F 3/065; G06F 3/067; G06F 3/064

(57) ABSTRACT

Exemplary methods include receiving a request to allocate a first block. In response to receiving the request, allocating the first block at a first location in a first storage device, and allocating a first replicated block of the first block at a second location in a second storage device, wherein a starting address of the first replicated block of the first block is immediately after an ending address of the first block. The methods include receiving a request to allocate a second block. In response to receiving the request, allocating the second block at a first location in a third storage device, and allocating a first replicated block of the second block at a second location in the first storage device, wherein a starting address of the first replicated block of the second block is immediately after an ending address of the second block.

### FIELD

Embodiments of the invention relate to the field of data storage systems; and more specifically, to the allocation of storage blocks in storage devices.

### BACKGROUND

A memory block is a logical or physical region in a memory. A “memory block” shall herein be simply referred to as “block”. Organization of blocks in memories is critical for high availability, replication, etc. Proper placement of blocks and memories provide efficient fault tolerance in case of hardware failures, and efficient use of memory. Conventionally, to increase or shrink replicated blocks wherein each replica needs to reside on a different memory, the number of memories needed is a multiple of replicas. For example, if replicas need to reside on different memories, to increase logical memory space, at least replica count of memories needs to be used. Since logical memory space is being increased by adding more memories, increasing the size of blocks is not an alternative.

FIG. 1A is a block diagram illustrating a conventional approach to organizing blocks in memories. As illustrated, block 100-A resides at location 120 in memory 110, and its replicated block (i.e., replica) 100-B resides at location 130 in memory 111. Block 101-A resides at location 121 in memory 110, and its replicated block 101-B resides at location 131 in memory 111. Assume that a new block needs to be allocated, and memories 110 and 111 do not have sufficient space to accommodate the new block. As illustrated in FIG. 1B, in order to allocate a new block which is to be replicated on a different memory, the conventional approach requires two additional memories to be added. As illustrated, newly allocated block 102-A resides at location 140 in newly added memory 112, and its replicated block 102-B resides at location 150 in newly added memory 113. Thus, a mechanism is needed which allows additional blocks to be allocated and replicated on different memories, wherein the number of newly added memories is not dependent on the number of replication.

### SUMMARY

Exemplary methods performed by a storage manager for allocating storage blocks in a plurality of storage devices to provide a logical storage space, include receiving a request to allocate a first storage block, wherein the first storage block is to be replicated a predetermined number of replication times, and wherein the first storage block and each of its replicated storage blocks are to be allocated in a different storage device. According to one embodiment, in response to receiving the request to allocate the first storage block, the methods further include allocating the first storage block at a first location in a first storage device, and allocating a first replicated storage block of the first storage block at a second location in a second storage device, wherein a starting address of the first replicated storage block of the first storage block is immediately after an ending address of the first storage block.

According to one embodiment, the methods further include receiving a request to allocate a second storage block, wherein the second storage block is to be replicated the predetermined number of replication times, and wherein the second storage block and each of its replicated storage blocks are to be allocated in a different storage device. According to one embodiment, the methods include in response to receiving the request to allocate the second storage block, allocating the second storage block at a first location in a third storage device, and allocating a first replicated storage block of the second storage block at a second location in the first storage device, wherein a starting address of the first replicated storage block of the second storage block is immediately after an ending address of the second storage block.

According to one embodiment, the methods further include receiving a request to allocate a third storage block, wherein the third storage block is to be replicated the predetermined number of replication times, and wherein the third storage block and each of its replicated storage blocks are to be allocated in a different storage device. In one embodiment, the methods include in response to receiving the request allocate the third storage block, allocating the third storage block at a first location in a fourth storage device, allocating a first replicated storage block of the third storage block at the second location in the first storage device, wherein the starting address of the first replicated storage block of the third storage block is immediately after an ending address of the third storage block, and allocating the first replicated storage block of the second storage block at a second location in the fourth storage device, wherein a starting address of the first replicated storage block of the second storage block is immediately after the ending address of the second storage block.

According to one embodiment, the methods further include receiving a request to de-allocate the third storage block and in response to receiving the request to de-allocate the third storage block, allocating the first replicated storage block of the second storage block at the second location in the first storage device, wherein the starting address of the first replicated storage block of the second storage block is immediately after the ending address of the second storage block.

According to one embodiment, the methods include receiving a request to allocate a fourth storage block, wherein the fourth storage block is to be replicated the predetermined number of replication times, and wherein the fourth storage block and each of its replicated storage blocks are to be allocated in a different storage device. The methods further include in response to receiving the request to allocate the fourth storage block, allocating the fourth storage block at a first location in a fifth storage device, and allocating a first replicated storage block of the fourth storage block at a second location in the fourth storage device, wherein a starting address of the first replicated storage block of the fourth storage block is immediately after an ending address of the fourth storage block, and allocating the first replicated storage block of the second storage block at a second location in the fifth storage device, wherein the starting address of the first replicated storage block of the second storage block is immediately after the ending address of the second storage block.

According to one embodiment, the methods further include receiving a request to de-allocate the third storage block, and in response to receiving the request to de-allocate the third storage block, allocating the first replicated storage block of the fourth storage block at the second location in the first storage device, wherein the starting address of the first replicated storage block of the fourth storage block is immediately after the ending address of the fourth storage block.

According to one embodiment, the methods further include receiving a request to de-allocate the second storage device and in response to receiving the request to de-allocate the second storage device, allocating the first replicated storage block of the first storage block at a second location in the third storage device, wherein the starting address of the first replicated storage block of the first storage block is immediately after the ending address of the first storage block.

According to one embodiment, the methods further include receiving a request to de-allocate the fourth storage device and in response to receiving the request to de-allocate the fourth storage device, allocating the first replicated storage block of the fourth storage block at the second location in the first storage device, wherein the starting address of the first replicated storage block of the fourth storage block is immediately after the ending address of the fourth storage block.

According to one embodiment, in response to receiving the request to allocate the first storage block, the methods further include creating a first contiguous region in a first storage device, and creating a second contiguous region in a second storage device, allocating the first storage block at a first location in that first region, and allocating a first replicated storage block of first storage block at a second location in that second region, wherein a relative starting address of the first replicated storage block from beginning of second region is immediately after relative ending address of the first storage block from beginning of first region.

According to one embodiment, the methods further include receiving a request to de-allocate the first storage device and in response to receiving the request to de-allocate the first storage device, allocating the first replicated storage block of the third storage block at the second location in the second storage device, wherein the starting address of the first replicated storage block of the third storage block is immediately after the ending address of the third storage block.

According to one embodiment, the methods further include maintaining a data structure that contains information indicating which storage blocks have been allocated, and for each allocated storage block the data structure contains information identifying which storage devices the allocated storage block and its replicated storage blocks are located in.

### BRIEF DESCRIPTION OF THE DRAWINGS

The invention may best be understood by referring to the following description and accompanying drawings that are used to illustrate embodiments of the invention. In the drawings:

FIG. 1A is a block diagram illustrating a conventional memory allocation mechanism.

FIG. 1B is a block diagram illustrating a conventional memory allocation mechanism.

FIG. 2 is a block diagram illustrating a system according to one embodiment.

FIG. 3A is a block diagram illustrating a mechanism for allocating storage blocks in storage devices according to one embodiment.

FIG. 3B is a block diagram illustrating a mechanism for allocating storage blocks in storage devices according to one embodiment.

FIG. 3C is a block diagram illustrating a mechanism for allocating storage blocks in storage devices according to one embodiment.

FIG. 3D is a block diagram illustrating a mechanism for allocating storage blocks in storage devices according to one embodiment.

FIG. 4 is a block diagram illustrating a mechanism for allocating storage blocks in storage devices according to one embodiment.

FIG. 5 is a block diagram illustrating a block map according to one embodiment.

FIG. 6 is a flow diagram illustrating a method for allocating storage blocks in storage devices according to one embodiment.

FIG. 7 is a block diagram illustrating a data processing system which may be used with one or more embodiments of the present invention.

### DESCRIPTION OF EMBODIMENTS

The following description describes methods and apparatus for allocating storage blocks in storage devices. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Techniques for efficiently allocating storage blocks (e.g., memory blocks and/or disk blocks) which are to be replicated on different storage devices (e.g., memories and/or disks) are described herein. According to one embodiment, a storage manager is configured to receive requests (e.g., from a system administrator) to allocate storage blocks (herein referred to simply as blocks). In response to each request, the storage manager determines which storage devices (herein referred to simply as devices) a block and its replica(s) are to be allocated in. The storage manager further determines where each block and its replica(s) are to be stored within each device.

According to one embodiment, the storage manager allocates the blocks and their replica(s) such that the devices are arranged in a circular list, and the blocks are allocated diagonally in the circular list of devices. As used herein, a “circular list of devices” refers to an organization of devices such that each block and its replica(s) are allocated in successive devices, wherein the first replica of the block allocated in the “last” device is allocated in the “first” device in the list. As used herein, “diagonal allocation” of blocks refers to an organization of blocks such that each block and its replica(s) are allocated contiguously in memory space. For example, the starting address of the first replica is immediately after the ending address of its respective block, and the starting address of the second replica is immediately after the ending address of the first replica, and so on. By allocating blocks diagonally in a circular list of devices, the present invention allows new blocks to be allocated without having to add a number of new memories that is dependent on the replication count. For example, contrary to a conventional approach, the present invention requires only a single memory to be added even though a new block is to be replicated multiple times on different devices.

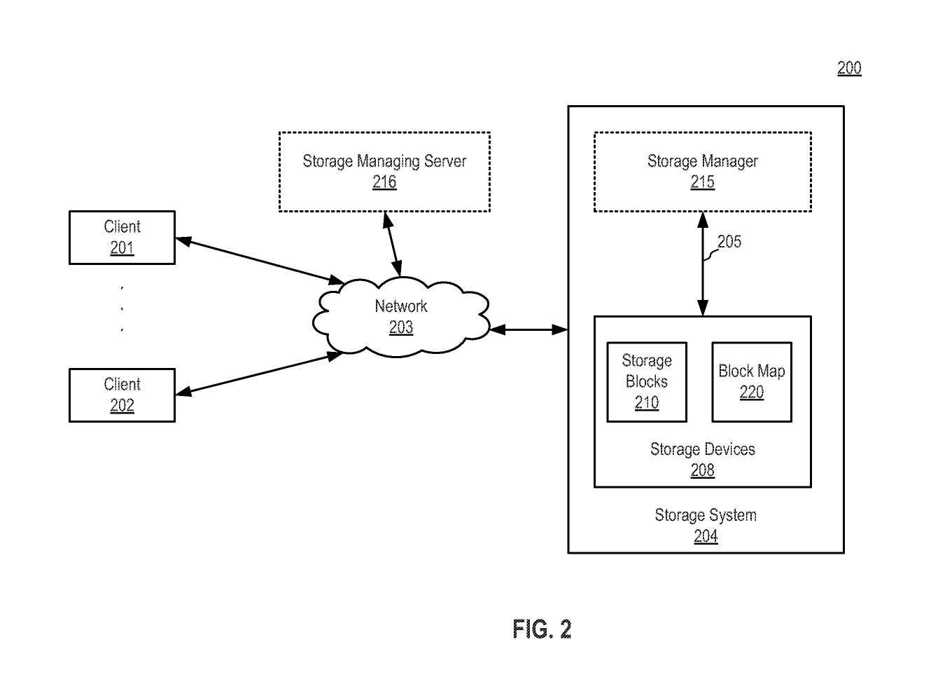

FIG. 2 is a block diagram illustrating a storage system according to one embodiment of the invention. System 200 includes, but is not limited to, one or more client systems 201-202 communicatively coupled to storage system 204 over network 203. Clients 201-202 may be any type of clients such as a server, a personal computer (e.g., workstation, laptop, netbook, tablet, palm top, mobile phone, smartphone, phablet, multimedia phone, Voice Over Internet Protocol (VOIP) phone, terminal, portable media player, GPS unit, wearable device, gaming system, set-top box, Internet enabled household appliance, etc.) Network 203 may be any type of network such as a local area network (LAN), a wide area network (WAN) such as the Internet, a corporate intranet, a metropolitan area network (MAN), a storage area network (SAN), a bus, or a combination thereof, wired and/or wireless.

Storage system 204 may include any type of server or cluster of servers. Storage system 204 may be, for example, a file server (e.g., an appliance used to provide network attached storage (NAS) capability), a block-based storage server (e.g., used to provide SAN capability), a unified storage device (e.g., one which combines NAS and SAN capabilities), a nearline storage device, a direct attached storage (DAS) device, a tape backup device, or essentially any other type of data storage device. Storage system 204 may have a distributed architecture, or all of its components may be integrated into a single unit.

In one embodiment, storage system 204 includes, but is not limited to, optional storage manager 215 communicatively coupled to storage devices 208. Storage devices 208 may be implemented locally or remotely via interconnect 205, which may be a bus and/or a network. Storage devices 208 may be, for example, conventional magnetic disks, magnetic tape storages, magneto-optical (MO) storage media, solid state disks, flash memory based devices, or any other type of non-volatile storage devices suitable for data. In embodiments where storage devices 208 are disk storage media, storage devices 208 may be organized into one or more volumes of Redundant Array of Inexpensive Disks (RAID). In one embodiment, each device of storage devices 208 is internally identified by a number (e.g., starting with 0), and each block of blocks 210 is also identified by a number (e.g., starting with 0). These identifying numbers are used for block allocation, described in further details below.

According to one embodiment, storage manager 215 is configured to receive requests (e.g., from a system administrator) to allocate blocks (e.g., blocks 210) in storage devices (e.g., devices 208) which can be used by clients (e.g., clients 201-202). According to one embodiment, each allocated block is to be replicated a predetermined number of replication times. In one such embodiment, each block and its replica(s) is to be allocated in a different device. In other words, each block and each of its replica is to be allocated/reside in a different storage device. According to one embodiment, storage manager 215 is to allocate the blocks and their replicas diagonally such that the devices form a circular list.

In one embodiment, storage manager 215 is further configured to maintain block map 220. Block map 220, in one embodiment, is implemented as a data structure that contains information indicating which storage blocks have been allocated, and for each allocated storage block, block map 220 contains information identifying which storage devices the allocated storage block and its replicated storage blocks (i.e., replicas) are located in. In one embodiment, block map 220 further contains information identifying the location within each device where each block is allocated. In one embodiment, block map 220 is stored in a persistent storage device and loaded into memory during operation.

According to one embodiment, storage manager 215 determines which devices to allocate a block and its replicas in using an equation similar to the following equation:

storage device=(B+R) % N Equation (1)

where B is the block number, R is the replica number, and N is the number of devices in the circular list that are being used to provide the logical storage space. Storage manager 215 determines the position in each device to allocate a block or its replica using an equation similar to the following equation:

position=X+R Equation (2)

where X is a predetermined offset. According to one embodiment, the determined “position” is then multiplied by the block size to determine the actual location in the device where the block starts. In other words, the starting address of a block is determined by multiplying the “position” by the block size, and the ending address is the starting address plus the block size minus 1.

By way of example, assume there are 2 storage devices in the list (i.e., N=2), each block is 2 gigabyte (GB), and the offset is 0 (i.e., X=0). The device in which a first block (i.e., B=0, R=0) is allocated is (0+0) % 2=0. The position within the device to allocate the first block is 0+0=0. Thus, the first block is to be allocated in device 0 at position 0. In this example, the block size is 2 GB, so the starting and ending address of the first block are “0” and “2 GB−1”, respectively.

Continuing on with the example, the device in which the first replica of the first block (i.e., B=0, R=1) is allocated is (0+1) % 2=1. The position within the device to allocate the first replica of the first block is 0+1=1. Thus, the first replica of the first block is to be allocated in device 1 at position 1. In this example, the block size is 2 GB, so the starting and ending address of the first replica of the first block are “2 GB” and “4 GB−1”, respectively.

It should be noted here that although the first block and its first replica are allocated in different devices, they are logically contiguous in memory space, i.e., the starting address of the first replica of the first block is immediately after the ending address of the first block. Thus, the first block and its first replica are “diagonally allocated” between device 0 and device 1.

Continuing on with the example, the device in which a second block (i.e., B=1, R=0) is allocated is (1+0) % 2=1. The position within the device to allocate the second block is 0+0=0. Thus, the second block is to be allocated in device 1 at position 0. In this example, the block size is 2 GB, so the starting and ending address of the second block are “0” and “2 GB−1”, respectively.

Continuing on with the example, the device in which the first replica of the second block (i.e., B=1, R=1) is allocated is (1+1) % 2=0. The position within the device to allocate the first replica of the second block is 0+1=1. Thus, the first replica of the second block is to be allocated in device 0 at position 1. In this example, the block size is 2 GB, so the starting and ending address of the first replica of the second block are “2 GB” and “4 GB−1”, respectively.

It should be noted here that although the second block and its first replica are allocated in different devices, they are logically contiguous in memory space, i.e., the starting address of the first replica of the second block is immediately after the ending address of the second block. Thus, the second block and its first replica are “diagonally allocated” between device 1 and device 0.

It should be further noted that the above example results in a circular list of 2 devices. The first block and its first replica are diagonally allocated between device 0 and device 1, and the second block and its first replica are diagonally allocated between device 1 and device 0.

Throughout the description, embodiments of the present invention are described as being performed by storage manager 215 located locally within storage system 204. It should be understood, however, that various embodiments of the present invention can be performed by a remote server. For example, the present mechanisms for allocating blocks can be performed by remote storage managing server 216 which is communicatively coupled to storage system 204 via network 203. In such an embodiment, storage managing server 216 communicates with a client/agent (not shown) at storage system 204 to allocate blocks 210 within storage devices 208. Although only one storage system is illustrated, it should be understood that storage managing server 215 can be configured to allocate blocks at multiple storage systems.

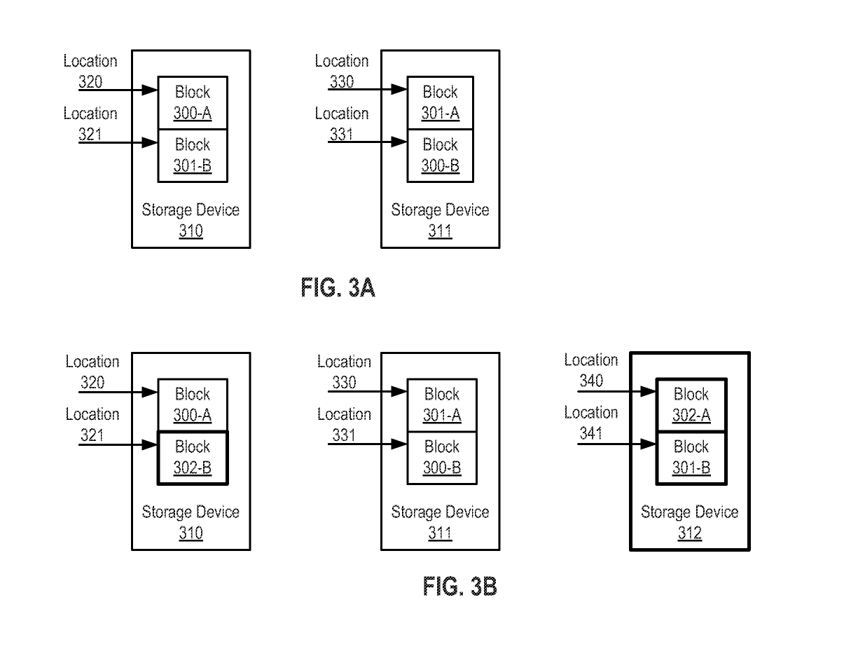

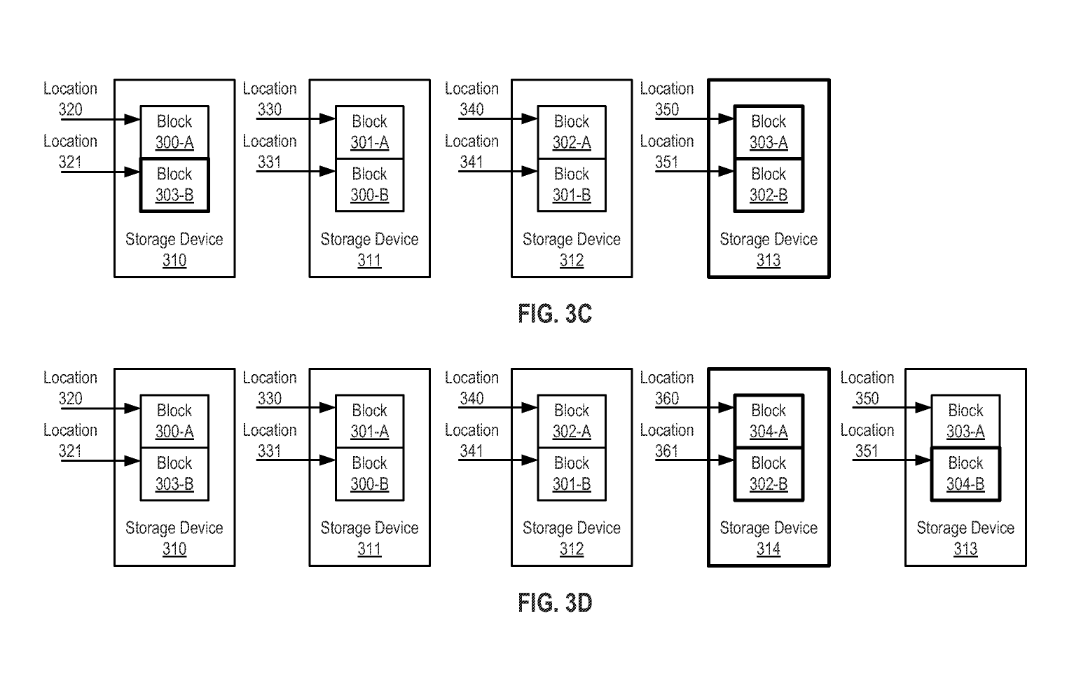

FIGS. 3A-3D are block diagrams illustrating block allocations according to one embodiment. Referring first to FIG. 3A, a storage manager (e.g., storage manager 215 or storage managing server 216) receives a first request (e.g., from a system administrator) to allocate a block, wherein the block is to be replicated a predetermined number of replication times (in this example 1), and wherein the block and each of its replica(s) is to be allocated in a different device. In response to the request, the storage manager uses equations similar to Equations (1) and (2) to allocate block 300-A at location 320 in device 310. The storage manager then replicates block 300-A as block 300-B, and allocates it at location 331 in device 311. It should be noted that blocks 300-A and its replica block 300-B are logically contiguous. That is to say, the starting address of replica block 300-B (i.e., location 331) is immediately after the ending address of block 300-A. Thus, blocks 300-A and 300-B are diagonally allocated in devices 310 and 311, respectively.

Referring still to FIG. 3A. The storage manager receives a second request to allocate a block, wherein the block is to be replicated a predetermined number of replication times (in this example 1), and wherein the block and each of its replica(s) is to be allocated in a different device. In response to the request, the storage manager uses equations similar to Equations (1) and (2) to allocate block 301-A at location 330 in device 311. The storage manager then replicates block 301-A as block 301-B, and allocates it at location 321 in device 310. It should be noted that blocks 301-A and its replica block 301-B are logically contiguous. That is to say, the starting address of replica block 301-B (i.e., location 321) is immediately after the ending address of block 301-A. Thus, blocks 301-A and 301-B are diagonally allocated in devices 311 and 310, respectively. It should be further noted that, by allocating replica block 301-B in device 310, the storage manager “wraps” the block back to the beginning of the list, thereby creating a “circular list” of devices.

Referring now to FIG. 3B. The storage manager receives a third request to allocate a block, wherein the block is to be replicated a predetermined number of replication times (in this example 1), and wherein the block and each of its replica(s) is to be allocated in a different device. In response to the request, the storage manager uses equations similar to Equations (1) and (2) to allocate block 302-A at location 340 in device 312. The storage manager then replicates block 302-A as block 302-B, and allocates it at location 321 in device 310. Further, the storage manager re-allocates replica block 301-B at location 341 in device 312. Thus, the circular list of devices has been expanded to include device 312.

It should be noted that blocks 301-A and its replica block 301-B are logically contiguous. That is to say, the starting address of replica block 301-B (i.e., location 341) is immediately after the ending address of block 301-A. Thus, blocks 301-A and 301-B are diagonally allocated in devices 311 and 312, respectively.

It should be noted that blocks 302-A and its replica block 302-B are logically contiguous. That is to say, the starting address of replica block 302-B (i.e., location 321) is immediately after the ending address of block 302-A. Thus, blocks 302-A and 302-B are diagonally allocated in devices 312 and 310, respectively. It should be noted that, by allocating replica block 302-B in device 310, the storage manager “wraps” the block back to the beginning of the list, thereby creating a “circular list” of devices.

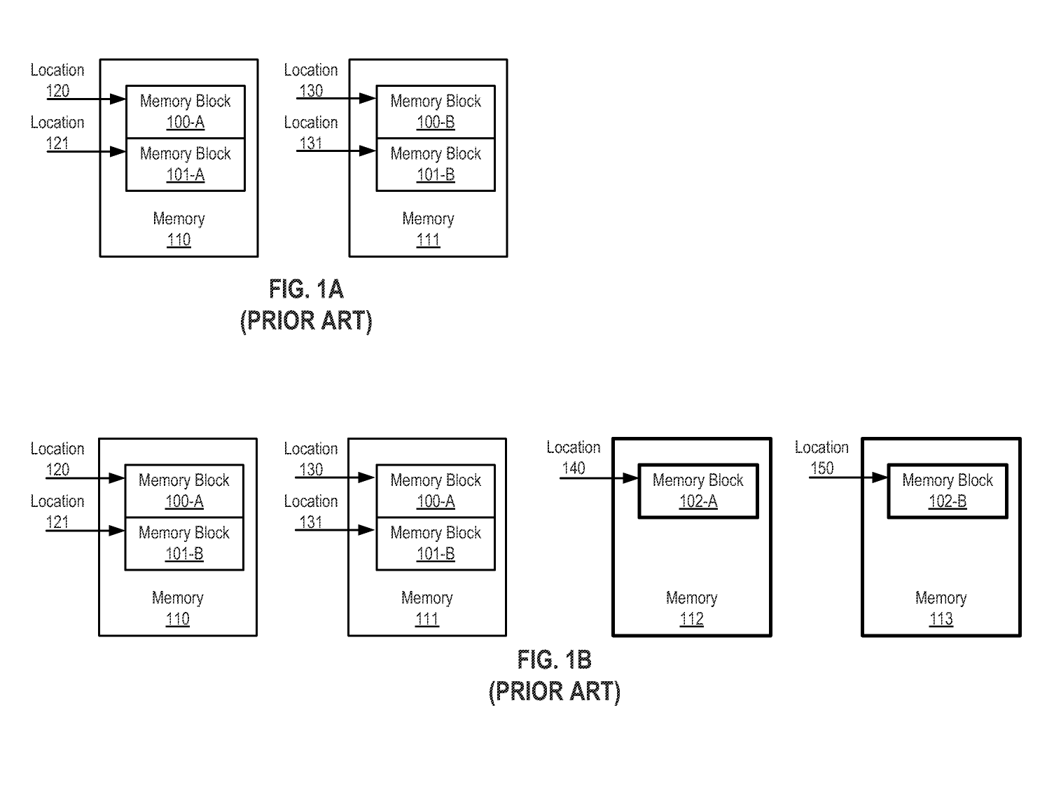

It should be noted that the storage manager, by using mechanisms of the present invention, only requires one additional storage device to allocate a new block, even though that new block has been replicated in different device. In contrast, the conventional mechanism (illustrated in FIG. 1B) requires two additional memories (i.e., memory 112 and 113) in order to allocate a new block and replicate it in a different memory.

Referring now to FIG. 3C. The storage manager receives a fourth request to allocate a block, wherein the block is to be replicated a predetermined number of replication times (in this example 1), and wherein the block and each of its replica(s) is to be allocated in a different device. In response to the request, the storage manager uses equations similar to Equations (1) and (2) to allocate block 303-A at location 350 in device 313. The storage manager then replicates block 303-A as block 303-B, and allocates it at location 321 in device 310. Further, the storage manager re-allocates replica block 302-B at location 351 in device 313. Thus, the circular list of devices has been expanded to include device 313.

It should be noted that blocks 302-A and its replica block 302-B are logically contiguous. That is to say, the starting address of replica block 302-B (i.e., location 351) is immediately after the ending address of block 302-A. Thus, blocks 302-A and 302-B are diagonally allocated in devices 312 and 313, respectively.

It should be noted that blocks 303-A and its replica block 303-B are logically contiguous. That is to say, the starting address of replica block 303-B (i.e., location 321) is immediately after the ending address of block 303-A. Thus, blocks 303-A and 303-B are diagonally allocated in devices 313 and 310, respectively. It should be noted that, by allocating replica block 303-B in device 310, the storage manager “wraps” the block back to the beginning of the list, thereby creating a “circular list” of devices.

It should be noted that the storage manager, by using mechanisms of the present invention, only requires one additional storage device to allocate a new block, even though that new block has been replicated in different device. In contrast, the conventional mechanism (illustrated in FIG. 1B) requires two additional memories (i.e., memory 112 and 113) in order to allocate a new block and replicate it in a different memory.

Referring now to FIG. 3D. The storage manager receives a fifth request to allocate a block, wherein the block is to be replicated a predetermined number of replication times (in this example 1), and wherein the block and each of its replica(s) is to be allocated in a different device. In response to the request, the storage manager uses equations similar to Equations (1) and (2) to allocate block 304-A at location 360 in device 314. The storage manager then replicates block 304-A as block 304-B, and allocates it at location 351 in device 313. Further, the storage manager re-allocates replica block 302-B at location 361 in device 314. Thus, the circular list of devices has been expanded to include device 314.

It should be noted that blocks 302-A and its replica block 302-B are logically contiguous. That is to say, the starting address of replica block 302-B (i.e., location 361) is immediately after the ending address of block 302-A. Thus, blocks 302-A and 302-B are diagonally allocated in devices 312 and 314, respectively.

It should be noted that blocks 304-A and its replica block 304-B are logically contiguous. That is to say, the starting address of replica block 304-B (i.e., location 351) is immediately after the ending address of block 304-A. Thus, blocks 304-A and 304-B are diagonally allocated in devices 314 and 313, respectively.

It should be noted that the storage manager, by using mechanisms of the present invention, only requires one additional storage device to allocate a new block, even though that new block has been replicated in different device. In contrast, the conventional mechanism (illustrated in FIG. 1B) requires two additional memories (i.e., memory 112 and 113) in order to allocate a new block and replicate it in a different memory.

It should be understood that the present mechanisms can be applied in “reverse order” in order to de-allocate a device. For example, in response to a request to de-allocate (i.e., remove) device 314 from the circular list, the storage manager is configured to re-allocate block 302-B at location 351 in device 313. In this way, device 314, blocks 304-A and its replica 304-B are removed from the circular list. Alternatively, or in addition to, in response to a request to de-allocate (i.e., remove) device 313 from the circular list, the storage manager is configured to re-allocate block 304-B at location 321 in device 310. In this way, device 313, blocks 303-A and its replica 303-B are removed from the circular list.

It should be understood that the present mechanisms can also be applied in “reverse order” in order to de-allocate a block. For example, in response to a request to de-allocate (i.e., remove) block 304-A from the circular list, the storage manager is configured to re-allocate block 302-B at location 351 in device 313. In this way, device 314, blocks 304-A and its replica 304-B are removed from the circular list. Alternatively, or in addition to, in response to a request to de-allocate (i.e., remove) block 303-A from the circular list, the storage manager is configured to re-allocate block 304-B at location 321 in device 310. In this way, device 313, blocks 303-A and its replica 303-B are removed from the circular list.

FIGS. 3A-3D illustrate examples of block allocation wherein each block is replicated once. It should be understood that the present invention is not so limited, and applies equally to configurations where each block is replicated more than once.

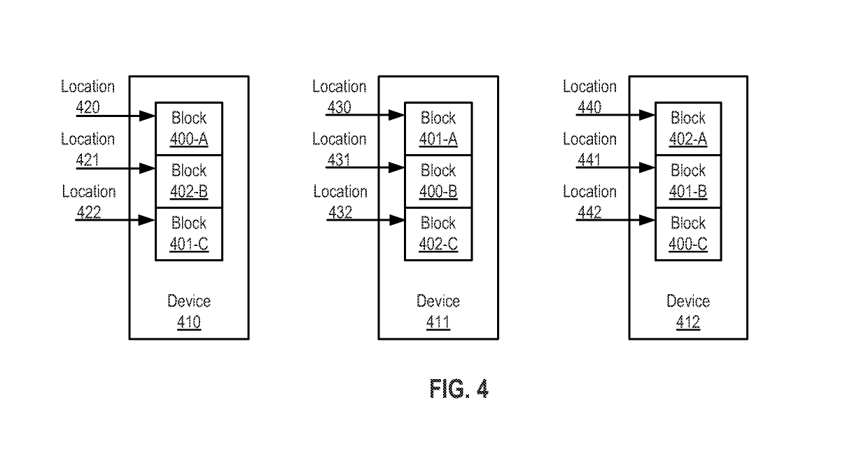

FIG. 4 is a block diagram illustrating block allocation according to one embodiment. For example, a storage manager (e.g., storage manager 215 or storage managing server 216) arranges/organizes the blocks and devices in FIG. 4 using equations similar to Equations (1) and (2), wherein each block is replicated twice. As illustrated, the storage manager allocates block 400-A at location 420 in device 410. Further, the storage manager replicates block 400-A as replicas 400-B and 400-C, and allocates them at locations 431 and 442, respectively, in devices 411 and 412, respectively. Blocks 400-A, 400-B, and 400-C are logically contiguous. For example, the starting address of block 400-B (i.e., location 431) is immediately after the ending address of block 400-A, and the starting address of block 400-C (i.e., location 442) is immediately after the ending address of block 400-B). In this way, the storage manager diagonally allocates block 400-A and its replicas 400-B and 400-C diagonally in devices 410, 411, and 412, respectively.

As illustrated in FIG. 4, the storage manager further allocates block 401-A at location 430 in device 411. Further, the storage manager replicates block 401-A as replicas 401-B and 401-C, and allocates them at locations 441 and 422, respectively, in devices 412 and 410, respectively. Blocks 401-A, 401-B, and 401-C are logically contiguous. For example, the starting address of block 401-B (i.e., location 441) is immediately after the ending address of block 401-A, and the starting address of block 401-C (i.e., location 422) is immediately after the ending address of block 401-B). In this way, the storage manager diagonally allocates block 401-A and its replicas 401-B and 401-C diagonally in devices 411, 412, and 410, respectively.

As illustrated in FIG. 4, the storage manager further allocates block 402-A at location 440 in device 412. Further, the storage manager replicates block 402-A as replicas 402-B and 402-C, and allocates them at locations 421 and 432, respectively, in devices 410 and 411, respectively. Blocks 402-A, 402-B, and 402-C are logically contiguous. For example, the starting address of block 402-B (i.e., location 421) is immediately after the ending address of block 402-A, and the starting address of block 402-C (i.e., location 432) is immediately after the ending address of block 402-B). In this way, the storage manager diagonally allocates block 402-A and its replicas 402-B and 402-C diagonally in devices 412, 410, and 411, respectively.

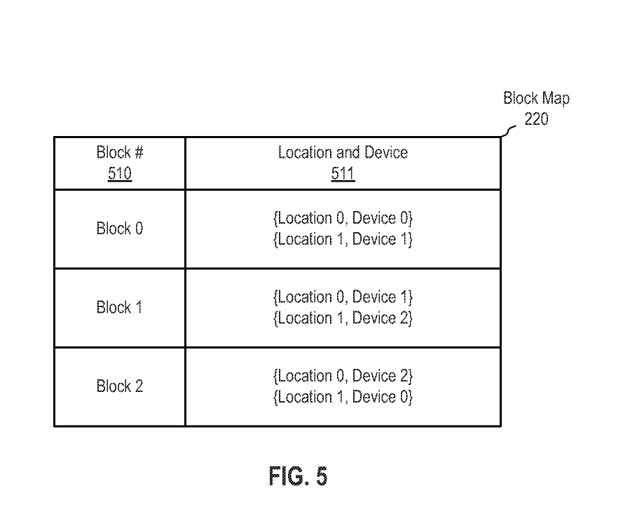

FIG. 5 is a block diagram illustrating block map 220 according to one embodiment. In one embodiment, block map 220 is implemented as a data structure, which can be stored in a non-volatile memory and loaded into memory during execution. Block map 220, according to one embodiment, includes columns 510 and 511. Column 510 contains information identifying one or more blocks, and column 511 contains information identifying one or more devices and locations within the respective devices. In one embodiment, each block identified in column 510 is allocated at a location in a device identified by corresponding information contained in column 511. In the illustrated example, block 0 is allocated at location 0 in device 0, and its replica is allocated at location 1 in device 1. FIG. 5 further illustrates that block 1 is allocated at location 0 in device 1, and its replica is allocated at location 1 in device 2. Further, FIG. 5 illustrates that block 2 is allocated at location 0 in device 2, and its replica is allocated at location 1 in device 0. The information is shown in FIG. 5 for illustrative purposes and not intended to be limitations of the present invention. One having ordinary skill in the art would recognize that more or less information can be included as part of block map 220. Further, block map 220 can be implemented as one or more data structures, having more or less columns.

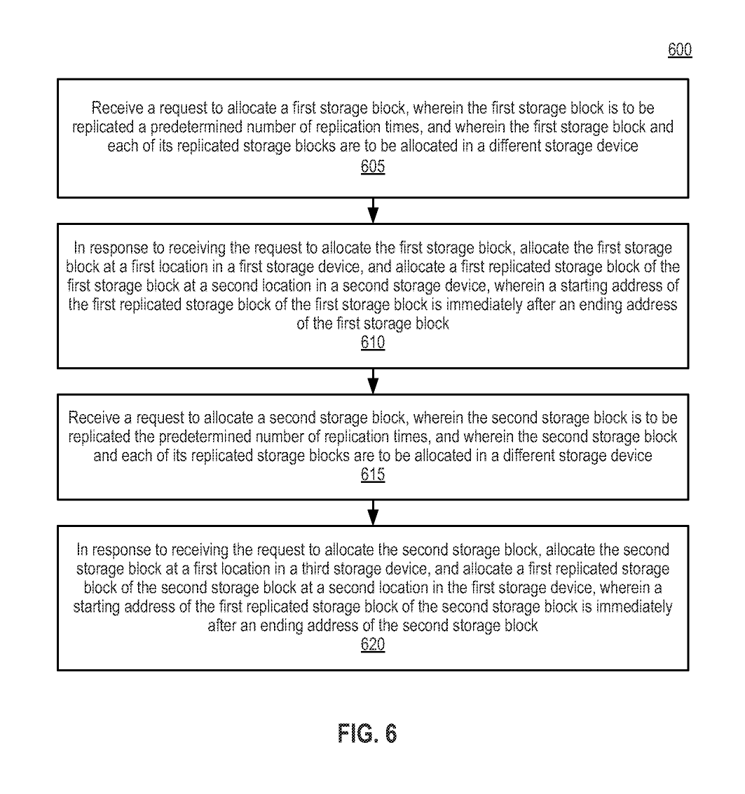

FIG. 6 is a flow diagram illustrating a method for performing block allocation according to one embodiment. For example, method 600 can be performed by a storage manager such as storage manager 215 or storage managing server 216, which can be implemented in software, firmware, hardware, or any combination thereof. The operations in this and other flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

Referring now to FIG. 6, at 605 the storage manager receives a request (e.g., from a system administrator) to allocate a first storage block (e.g., block 300-A), wherein the first storage block is to be replicated a predetermined number of replication times (e.g., once), and wherein the first storage block (e.g., block 300-A) and each of its replicated storage blocks (e.g., block 300-B) are to be allocated in a different storage device (e.g., block 300-A is allocated in device 310 and replica block 300-B is allocated in device 311).

At block 610, the storage manager in response to receiving the request to allocate the first storage block, allocates the first storage block at a first location (e.g., location 320) in a first storage device (e.g., device 310), and allocates a first replicated storage block (e.g., block 300-B) of the first storage block at a second location (e.g., location 331) in a second storage device (e.g., device 311), wherein a starting address (e.g., location 331) of the first replicated storage block of the first storage block is immediately after an ending address of the first storage block (e.g., block 300-A).

At block 615, the storage manager receives a request to allocate a second storage block (e.g., block 301-A or 302-A), wherein the second storage block is to be replicated the predetermined number of replication times, and wherein the second storage block (301-A or 302-A) and each of its replicated storage blocks (block 301-B or 302-B) are to be allocated in a different storage device.

At block 620, the storage manager in response to receiving the request to allocate the second storage block, allocates the second storage block (e.g., block 301-A or 302-A) at a first location (e.g., location 330 or 340) in a third storage device (e.g., device 311 or 312), and allocates a first replicated storage block (e.g., block 301-B or 302-B) of the second storage block at a second location (e.g., location 321) in the first storage device (e.g., device 310), wherein a starting address of the first replicated storage block (e.g., location 321) of the second storage block is immediately after an ending address of the second storage block (e.g., block 301-A or 302-A).

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

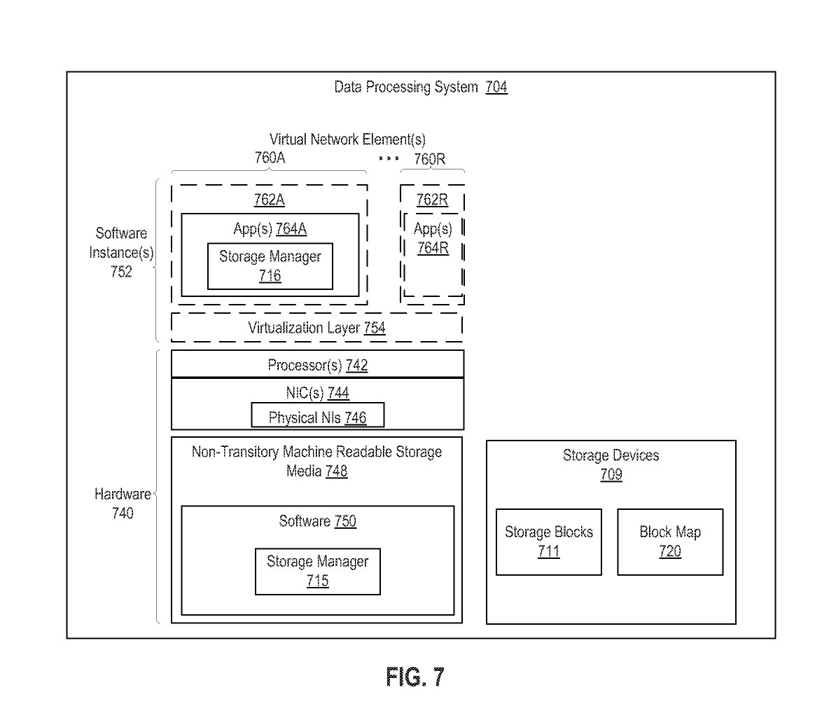

FIG. 7 is a block diagram illustrating a data processing system which may be used with one or more embodiments of the present invention. A data processing system is an electronic device that communicatively interconnects other electronic devices on the network (e.g., other network devices, end-user devices). According to one embodiment, data processing system 704 includes hardware 740 comprising a set of one or more processor(s) 742 and network interface controller(s) 744 (NICs; also known as network interface cards) (which include physical network interfaces (NIs) 746), as well as non-transitory machine readable storage media 748 having stored therein software 750. During operation, the processor(s) 742 execute the software 750 to instantiate one or more sets of one or more applications 764A-R. While one embodiment does not implement virtualization, alternative embodiments may use different forms of virtualization—represented by a virtualization layer 754 and software containers 762A-R. For example, one such alternative embodiment implements operating system-level virtualization, in which case the virtualization layer 754 represents the kernel of an operating system (or a shim executing on a base operating system) that allows for the creation of multiple software containers 762A-R that may each be used to execute one of the sets of applications 764A-R. In this embodiment, the multiple software containers 762A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 754 represents a hypervisor (sometimes referred to as a virtual machine monitor (VMM)) or a hypervisor executing on top of a host operating system; and 2) the software containers 762A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 764A-R, as well as the virtualization layer 754 and software containers 762A-R if implemented, are collectively referred to as software instance(s) 752. Each set of applications 764A-R, corresponding software container 762A-R if implemented, and that part of the hardware 740 that executes them (be it hardware dedicated to that execution and/or time slices of hardware temporally shared by software containers 762A-R), forms a separate virtual network element(s) 760A-R.

In certain embodiments, the virtualization layer 754 includes a virtual switch that provides similar forwarding services as a physical Ethernet switch. Specifically, this virtual switch forwards traffic between software containers 762A-R and the NIC(s) 744, as well as optionally between the software containers 762A-R; in addition, this virtual switch may enforce network isolation between the VNEs 760A-R that by policy are not permitted to communicate with each other (e.g., by honoring virtual local area networks (VLANs)).

According to one embodiment, software 750 includes code which when executed by processor(s) 742, causes processor(s) 742 to perform operations of one or more embodiments of the present invention as part software instances 752. For example, software 750 includes storage manager 715, which when executed by processor(s) 742, causes the instantiation of storage manager 716 which performs operations similar to those performed by storage manager 215 or storage managing server 216. In one embodiment, hardware 740 includes storage devices 709 (e.g., storage disks, memories, etc.) which comprises storage blocks 711 allocated by storage manager 716 using mechanisms similar to those described above. In one embodiment, storage devices 709 include block map 720, which contains information similar to those contained in block map 220.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

1. A computer-implemented method for allocating storage blocks in a plurality of storage devices to provide a logical storage space, the method comprising:
receiving a request to allocate a first storage block, wherein the first storage block is to be replicated a predetermined number of replication times, and wherein the first storage block and each of its replicated storage blocks are to be allocated in a different storage device;
in response to receiving the request to allocate the first storage block, allocating the first storage block at a first location in a first storage device, and
allocating a first replicated storage block of the first storage block at a second location in a second storage device, wherein a starting address of the first replicated storage block of the first storage block is immediately after an ending address of the first storage block;
receiving a request to allocate a second storage block, wherein the second storage block is to be replicated the predetermined number of replication times, and wherein the second storage block and each of its replicated storage blocks are to be allocated in a different storage device; and
in response to receiving the request to allocate the second storage block,
allocating the second storage block at a first location in a third storage device, and
allocating a first replicated storage block of the second storage block at a second location in the first storage device, wherein a starting address of the first replicated storage block of the second storage block is immediately after an ending address of the second storage block.

2. The method of claim 1, further comprising:
receiving a request to allocate a third storage block, wherein the third storage block is to be replicated the predetermined number of replication times, and wherein the third storage block and each of its replicated storage blocks are to be allocated in a different storage device; and
in response to receiving the request allocate the third storage block,
allocating the third storage block at a first location in a fourth storage device,
allocating a first replicated storage block of the third storage block at the second location in the first storage device, wherein the starting address of the first replicated storage block of the third storage block is immediately after an ending address of the third storage block, and
allocating the first replicated storage block of the second storage block at a second location in the fourth storage device, wherein a starting address of the first replicated storage block of the second storage block is immediately after the ending address of the second storage block.

3. The method of claim 2, further comprising:
receiving a request to de-allocate the third storage block; and
in response to receiving the request to de-allocate the third storage block,
allocating the first replicated storage block of the second storage block at the second location in the first storage device, wherein the starting address of the first replicated storage block of the second storage block is immediately after the ending address of the second storage block.

4. The method of claim 2, further comprising:
receiving a request to allocate a fourth storage block, wherein the fourth storage block is to be replicated the predetermined number of replication times, and wherein the fourth storage block and each of its replicated storage blocks are to be allocated in a different storage device; and
in response to receiving the request to allocate the fourth storage block,
allocating the fourth storage block at a first location in a fifth storage device,
allocating a first replicated storage block of the fourth storage block at a second location in the fourth storage device, wherein a starting address of the first replicated storage block of the fourth storage block is immediately after an ending address of the fourth storage block, and
allocating the first replicated storage block of the second storage block at a second location in the fifth storage device, wherein the starting address of the first replicated storage block of the second storage block is immediately after the ending address of the second storage block.

5. The method of claim 4, further comprising:
receiving a request to de-allocate the third storage block; and
in response to receiving the request to de-allocate the third storage block,
allocating the first replicated storage block of the fourth storage block at the second location in the first storage device, wherein the starting address of the first replicated storage block of the fourth storage block is immediately after the ending address of the fourth storage block.

6. The method of claim 4, further comprising:
receiving a request to de-allocate the second storage device; and
in response to receiving the request to de-allocate the second storage device,
allocating the first replicated storage block of the first storage block at a second location in the third storage device, wherein the starting address of the first replicated storage block of the first storage block is immediately after the ending address of the first storage block.

7. The method of claim 4, further comprising:
receiving a request to de-allocate the fourth storage device; and
in response to receiving the request to de-allocate the fourth storage device,
allocating the first replicated storage block of the fourth storage block at the second location in the first storage device, wherein the starting address of the first replicated storage block of the fourth storage block is immediately after the ending address of the fourth storage block.

8. The method of claim 4, further comprising:
receiving a request to de-allocate the first storage device; and
in response to receiving the request to de-allocate the first storage device,
allocating the first replicated storage block of the third storage block at the second location in the second storage device, wherein the starting address of the first replicated storage block of the third storage block is immediately after the ending address of the third storage block.

9. The method of claim 1, further comprising:
maintaining a data structure that contains information indicating which storage blocks have been allocated, and for each allocated storage block the data structure contains information identifying which storage devices the allocated storage block and its replicated storage blocks are located in.

10. A data processing system for allocating storage blocks in a plurality of storage devices to provide a logical storage space, the data processing system comprising:
a set of one or more processors; and
a non-transitory machine-readable storage medium containing code, which when executed by the set of one or more processors, causes the data processing system to:
receive a request to allocate a first storage block, wherein the first storage block is to be replicated a predetermined number of replication times, and wherein the first storage block and each of its replicated storage blocks are to be allocated in a different storage device;
in response to receiving the request to allocate the first storage block,
allocate the first storage block at a first location in a first storage device, and
allocate a first replicated storage block of the first storage block at a second location in a second storage device, wherein a starting address of the first replicated storage block of the first storage block is immediately after an ending address of the first storage block;
receive a request to allocate a second storage block, wherein the second storage block is to be replicated the predetermined number of replication times, and wherein the second storage block and each of its replicated storage blocks are to be allocated in a different storage device; and
in response to receiving the request to allocate the second storage block,
allocate the second storage block at a first location in a third storage device, and
allocate a first replicated storage block of the second storage block at a second location in the first storage device, wherein a starting address of the first replicated storage block of the second storage block is immediately after an ending address of the second storage block.

11. The data processing system of claim 10, wherein the non-transitory machine-readable storage medium further contains code, which when executed by the set of one or more processors, causes the data processing system to:
receive a request to allocate a third storage block, wherein the third storage block is to be replicated the predetermined number of replication times, and wherein the third storage block and each of its replicated storage blocks are to be allocated in a different storage device; and
in response to receiving the request allocate the third storage block,
allocate the third storage block at a first location in a fourth storage device,
allocate a first replicated storage block of the third storage block at the second location in the first storage device, wherein the starting address of the first replicated storage block of the third storage block is immediately after an ending address of the third storage block, and
allocate the first replicated storage block of the second storage block at a second location in the fourth storage device, wherein a starting address of the first replicated storage block of the second storage block is immediately after the ending address of the second storage block.

12. The data processing system of claim 11, wherein the non-transitory machine-readable storage medium further contains code, which when executed by the set of one or more processors, causes the data processing system to:
receive a request to de-allocate the third storage block; and
in response to receiving the request to de-allocate the third storage block,
allocate the first replicated storage block of the second storage block at the second location in the first storage device, wherein the starting address of the first replicated storage block of the second storage block is immediately after the ending address of the second storage block.

13. The data processing system of claim 11, wherein the non-transitory machine-readable storage medium further contains code, which when executed by the set of one or more processors, causes the data processing system to:
receive a request to allocate a fourth storage block, wherein the fourth storage block is to be replicated the predetermined number of replication times, and wherein the fourth storage block and each of its replicated storage blocks are to be allocated in a different storage device; and
in response to receiving the request to allocate the fourth storage block,
allocate the fourth storage block at a first location in a fifth storage device,
allocate a first replicated storage block of the fourth storage block at a second location in the fourth storage device, wherein a starting address of the first replicated storage block of the fourth storage block is immediately after an ending address of the fourth storage block, and
allocate the first replicated storage block of the second storage block at a second location in the fifth storage device, wherein the starting address of the first replicated storage block of the second storage block is immediately after the ending address of the second storage block.

14. The data processing system of claim 13, wherein the non-transitory machine-readable storage medium further contains code, which when executed by the set of one or more processors, causes the data processing system to:
receive a request to de-allocate the third storage block; and
in response to receiving the request to de-allocate the third storage block,
allocate the first replicated storage block of the fourth storage block at the second location in the first storage device, wherein the starting address of the first replicated storage block of the fourth storage block is immediately after the ending address of the fourth storage block.

15. The data processing system of claim 13, wherein the non-transitory machine-readable storage medium further contains code, which when executed by the set of one or more processors, causes the data processing system to:
receive a request to de-allocate the second storage device; and
in response to receiving the request to de-allocate the second storage device,
allocate the first replicated storage block of the first storage block at a second location in the third storage device, wherein the starting address of the first replicated storage block of the first storage block is immediately after the ending address of the first storage block.

16. The data processing system of claim 13, wherein the non-transitory machine-readable storage medium further contains code, which when executed by the set of one or more processors, causes the data processing system to:
receive a request to de-allocate the fourth storage device; and
in response to receiving the request to de-allocate the fourth storage device,
allocate the first replicated storage block of the fourth storage block at the second location in the first storage device, wherein the starting address of the first replicated storage block of the fourth storage block is immediately after the ending address of the fourth storage block.

17. The data processing system of claim 13, wherein the non-transitory machine-readable storage medium further contains code, which when executed by the set of one or more processors, causes the data processing system to:
receive a request to de-allocate the first storage device; and
in response to receiving the request to de-allocate the first storage device,
allocate the first replicated storage block of the third storage block at the second location in the second storage device, wherein the starting address of the first replicated storage block of the third storage block is immediately after the ending address of the third storage block.

18. The data processing system of claim 10, wherein the non-transitory machine-readable storage medium further contains code, which when executed by the set of one or more processors, causes the data processing system to:
maintain a data structure that contains information indicating which storage blocks have been allocated, and for each allocated storage block the data structure contains information identifying which storage devices the allocated storage block and its replicated storage blocks are located in.

19. A non-transitory computer-readable storage medium having computer code stored therein, which when executed by a processor of a data processing system for allocating storage blocks in a plurality of storage devices to provide a logical storage space, causes the data processing system to perform operations comprising:
receiving a request to allocate a first storage block, wherein the first storage block is to be replicated a predetermined number of replication times, and wherein the first storage block and each of its replicated storage blocks are to be allocated in a different storage device;
in response to receiving the request to allocate the first storage block,
allocating the first storage block at a first location in a first storage device, and
allocating a first replicated storage block of the first storage block at a second location in a second storage device, wherein a starting address of the first replicated storage block of the first storage block is immediately after an ending address of the first storage block;
receiving a request to allocate a second storage block, wherein the second storage block is to be replicated the predetermined number of replication times, and wherein the second storage block and each of its replicated storage blocks are to be allocated in a different storage device; and
in response to receiving the request to allocate the second storage block,
allocating the second storage block at a first location in a third storage device, and
allocating a first replicated storage block of the second storage block at a second location in the first storage device, wherein a starting address of the first replicated storage block of the second storage block is immediately after an ending address of the second storage block.

20. The non-transitory computer-readable storage medium of claim 19, further comprising:
receiving a request to allocate a third storage block, wherein the third storage block is to be replicated the predetermined number of replication times, and wherein the third storage block and each of its replicated storage blocks are to be allocated in a different storage device; and
in response to receiving the request allocate the third storage block,
allocating the third storage block at a first location in a fourth storage device,
allocating a first replicated storage block of the third storage block at the second location in the first storage device, wherein the starting address of the first replicated storage block of the third storage block is immediately after an ending address of the third storage block, and
allocating the first replicated storage block of the second storage block at a second location in the fourth storage device, wherein a starting address of the first replicated storage block of the second storage block is immediately after the ending address of the second storage block.

21. The non-transitory computer-readable storage medium of claim 20, further comprising:
receiving a request to de-allocate the third storage block; and
in response to receiving the request to de-allocate the third storage block,
allocating the first replicated storage block of the second storage block at the second location in the first storage device, wherein the starting address of the first replicated storage block of the second storage block is immediately after the ending address of the second storage block.

22. The non-transitory computer-readable storage medium of claim 20, further comprising:
receiving a request to allocate a fourth storage block, wherein the fourth storage block is to be replicated the predetermined number of replication times, and wherein the fourth storage block and each of its replicated storage blocks are to be allocated in a different storage device; and
in response to receiving the request to allocate the fourth storage block,
allocating the fourth storage block at a first location in a fifth storage device,
allocating a first replicated storage block of the fourth storage block at a second location in the fourth storage device, wherein a starting address of the first replicated storage block of the fourth storage block is immediately after an ending address of the fourth storage block, and
allocating the first replicated storage block of the second storage block at a second location in the fifth storage device, wherein the starting address of the first replicated storage block of the second storage block is immediately after the ending address of the second storage block.

23. The non-transitory computer-readable storage medium of claim 22, further comprising:
receiving a request to de-allocate the third storage block; and
in response to receiving the request to de-allocate the third storage block,
allocating the first replicated storage block of the fourth storage block at the second location in the first storage device, wherein the starting address of the first replicated storage block of the fourth storage block is immediately after the ending address of the fourth storage block.

24. The non-transitory computer-readable storage medium of claim 22, further comprising:
receiving a request to de-allocate the second storage device; and
in response to receiving the request to de-allocate the second storage device,
allocating the first replicated storage block of the first storage block at a second location in the third storage device, wherein the starting address of the first replicated storage block of the first storage block is immediately after the ending address of the first storage block.

25. The non-transitory computer-readable storage medium of claim 22, further comprising:
receiving a request to de-allocate the fourth storage device; and
in response to receiving the request to de-allocate the fourth storage device,
allocating the first replicated storage block of the fourth storage block at the second location in the first storage device, wherein the starting address of the first replicated storage block of the fourth storage block is immediately after the ending address of the fourth storage block.

26. The non-transitory computer-readable storage medium of claim 22, further comprising:
receiving a request to de-allocate the first storage device; and
in response to receiving the request to de-allocate the first storage device,
allocating the first replicated storage block of the third storage block at the second location in the second storage device, wherein the starting address of the first replicated storage block of the third storage block is immediately after the ending address of the third storage block.

27. The non-transitory computer-readable storage medium of claim 19, further comprising:
maintaining a data structure that contains information indicating which storage blocks have been allocated, and for each allocated storage block the data structure contains information identifying which storage devices the allocated storage block and its replicated storage blocks are located in.
